(19) United States
(12) Patent Application Publication
(10) Pub. No.: US 2005/0040829 A1
(43) Pub. Date: Feb. 24, 2005

(54) Battery power detecting method and device

(76) Inventor: Shih-Zheng Kuo, Taipei (TW)

Correspondence Address: LOWE HAUPTMAN GILMAN & BERNER, LLP, Suite 310, 1700 Diagonal Road, Alexandria, VA, 22314, US

(21) Appl. No.: 10/645,563

(22) Filed: Aug. 22, 2003

(51) Int. Cl. G01N 27/416

(52) U.S. Cl. 324/433

(57) ABSTRACT

The present invention provides a circuit structure that has a device to calculate the actual voltage of the battery power device, wherein the device such as diode has the constant reference voltage that used to replace the first resistor within the conventional measuring circuit structure, and without using constant voltage regulator within the measuring circuit. The diode can provides a constant reference voltage to the measuring circuit, such that the value of the signal output terminal is increased by decreased the voltage of the battery power, when the voltage is applied to the measuring circuit. Thus, the signal outputted terminal could be compared with the default within said measuring circuit the voltage of the battery is enough to apply the measuring circuit to perform the measuring operation.

### BACKGROUND OF THE INVENTION

1. Field of the Invention

The present invention generally relates to a measuring circuit structure to determine the power voltage of the battery, and more particularly to a device with a constant reference voltage that installed within the measuring circuit, and compared the output value of the signal outputted terminal and the setting within the measuring circuit to determine the voltage power is sufficient within the battery.

2. Description of the Prior Art

In the conventional circuit, the voltage cannot be directly determined from the reference voltage within the measuring circuit, when the voltage is insufficient. Thus, the measuring circuit cannot be operated during the under-voltage, and the operation would be re-starting to increase the cost.

FIG. 1 is a schematic representation for showing a measuring circuit within a blood glucose meter. The measuring circuit comprises a first resistor 110, a second resistor 112, a voltage-inputted terminal (V_{DD}) 114, a constant voltage regulator 116, ADC device (analog to digital converting) 118, and a digital outputted terminal (Dₒᵤₜ) 120. The first resistor 110 is electrically coupled to the second resistor 112 in series connection, and a terminal of the first resistor 110 is grounded 122. Furthermore, the voltage inputted terminal 114 of the battery provides the power to the blood glucose meter to measure the concentration of the blood glucose, and is electrically coupled to the second resistor 112 and a constant voltage regulator 116. Next, the constant voltage regulator 116 is electrically coupled to the ADC device 118, herein, the constant voltage regulator 116 used to provide a constant voltage to the ADC 118 to fix the operating voltage of the ADC device 118. In addition, the terminal of the ADC device 118 is electrically coupled to the connecting point that between the first resistor 110 and second resistor 112, and another terminal of the ADC device 118 is grounded. Thereafter, the output terminal of the ADC device 118 is electrically coupled to the signal-outputted terminal 120, wherein the signal-outputted terminal 120 used to output the digital signal.

In the conventional operating process, the voltage-inputted terminal 114 used to provide the operating power to the blood glucose meter. According to the Kirchhiff's voltage law, the first resistor 110 has the voltage as well as the second resistor 112, therefore, the voltage can be calculate by a first equation, V_{ADC}=V_{DD}*R₁/R₁+R₂, wherein the V_{ADC} is the voltage of the ADC device 118, the V_{DD} is the voltage of the voltage-inputted terminal 114, and R₁ and R₂ is a resistance of the first resistor 110 and second resistor 112, respectively. Furthermore, the constant voltage regulator 116 provides a constant voltage is of about 2.5 volts to the ADC device 118. Therefore, the voltage of the signal-outputted terminal 120 that can be calculate by the second equation, Dₒᵤₜ=255/2.5*V_{DD}, wherein the Dₒᵤₜ, is an output value of the signal outputted terminal 120, the value 255 is transformed from 8 bit that correspond to ADC device 118. Thus, the digital outputted value could be estimated by using the second equation. To compare the digital outputted value and the setting value within the measuring circuit, when the digital outputted value is under setting value, that is to say, the voltage of the battery is not sufficient to provide to the measuring circuit to operate. Furthermore, the value of the signal-outputted terminal 114 is proportion to the outputted voltage. Nevertheless, the user cannot determine the voltage power is sufficient to the blood glucose meter to perform the measuring operating from the signal-outputted terminal 120. Moreover, the blood glucose meter would be shut down during the operating, so as to the blood glucose meter would be re-start to increase the measuring time and cost.

### SUMMARY OF THE INVENTION

It is an object of this invention to provide a device with a constant reference voltage within the measuring circuit to overcome the problem in accordance with the conventional prior art.

It is another object of this invention to determine the voltage of the battery is enough to operate by using a device with a constant reference voltage that compare with the voltage of the battery.

It is yet object of this invention to provide a device with a constant reference voltage within the measuring circuit to lower the manufacturing cost.

It is still object of this invention to provide a method to obtain the remaining voltage of the battery to maintain the normal operation of the blood glucose meter.

According to above-mentioned objects, the present invention provides a device with a constant reference voltage within a measuring circuit to estimate an actual voltage value of the battery, wherein the device such as a diode has a constant reference voltage that can replace the first resistor and the constant voltage regulator within the conventional measuring circuit. Then, a terminal of the diode is grounded, the terminal of the resistor is electrically coupled to the diode, and the other terminal of the resistor is electrically coupled to the voltage-inputted terminal. Furthermore, an ADC device (analog to digital converting device) is electrically coupled to a connecting point that between the diode and the resistor, and also is electrically coupled to a connecting point between the voltage-inputted terminal of the battery and another terminal of the diode, and the outputted terminal of the ADC device is electrically coupled to the digital signal outputted terminal.

When the voltage inputted terminal of the battery supplied an operating voltage to the measuring circuit, because of the diode has a constant voltage, such that the change in the outputted signal at the digital signal outputted terminal is inverse proportion to the voltage inputted terminal of the battery. Thus, the voltage of the battery is sufficient for the measuring operation in the measuring circuit, which can be directed determine by comparing the digital signal value in the signal-outputted terminal with the setting value within the measuring circuit.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic representation for showing a conventional measuring circuit within the blood glucose meter; and

FIG. 2 is a schematic representation for showing a device with a constant reference voltage within the measuring circuit to replace the resistor to estimate the voltage is sufficient for the battery for measuring operation.

### DESCRIPTION OF THE PREFERRED EMBODIMENT

Some sample embodiments of the invention will now be described in greater detail. Nevertheless, it should be recognized that the present invention can be practiced in a wide range of other embodiments besides those explicitly described, and the scope of the present invention is expressly not limited except as specified in the accompanying claims.

The present invention provides a device with a constant reference voltage within a measuring circuit to estimate the actual voltage of the battery, and to compare the outputted voltage of the digital outputted terminal with the setting value with the measuring circuit, wherein the device with constant reference voltage such as a diode is used to replace the first resistor, and without using the constant voltage regulator in the measuring circuit. The first terminal of the diode is electrically coupled to the second terminal of the resistor, and further the second terminal of the diode is grounded, the first terminal of the resistor is electrically coupled to the voltage-inputted terminal of the battery. Because the diode has a constant reference voltage to maintain the voltage within the measuring circuit, such that the digital value at the digital signal outputted terminal could compare with the setting voltage to determine the voltage is sufficient for measuring operation.

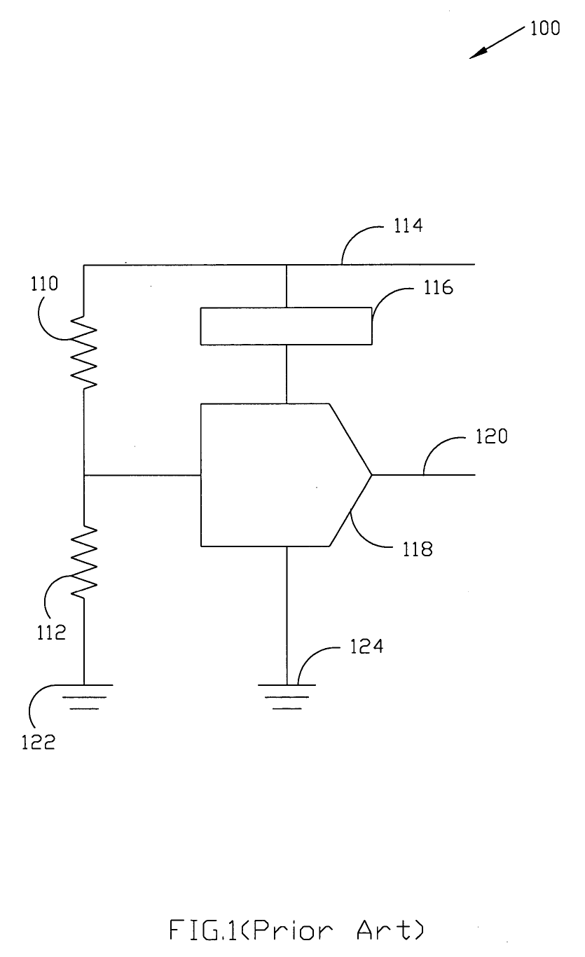

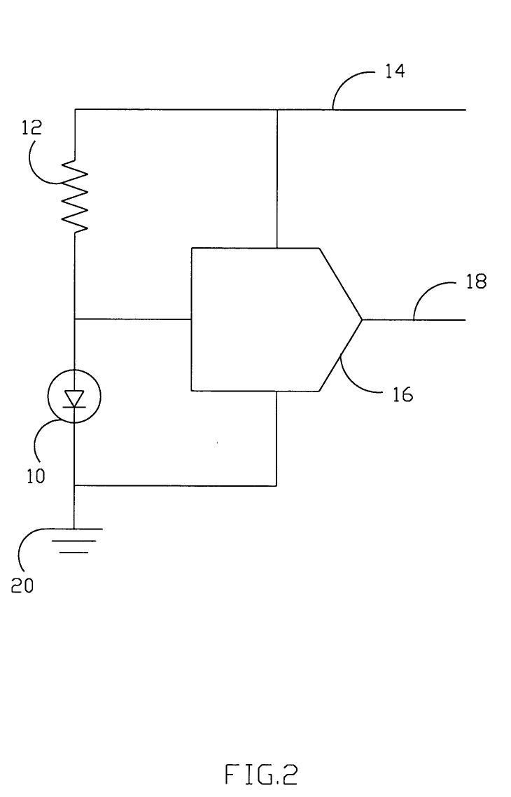

FIG. 2 is a schematic representation for showing a measuring circuit structure in accordance with preferred embodiment of the present invention. The diode with a constant reference voltage is used to replace the first resistor 110 (as shown in FIG. 1), and without using the constant voltage regulator 116 (as shown in FIG. 1) to provide the constant reference voltage to the ADC device 16 in the measuring circuit to simply the circuit structure of the measuring circuit.

In the preferred embodiment of the present invention, the first terminal of the diode 10 is electrically coupled to the second terminal of the resistor 12, and the second terminal of the diode 10 is grounded 20. Furthermore, the first terminal of the resistor 12 is electrically coupled to the voltage-inputted terminal of the battery 14, and the first terminal of the diode 10 and the second terminal of the resistor 12 are electrically coupled to the second terminal of the ADC device (analog to digital converting device) 16 simultaneously. Then, the first terminal of the ADC device 16 is electrically coupled to the voltage-inputted terminal 14 of the battery, and the third terminal of the ADC device 16 is electrically coupled to the second terminal of the diode 10. In addition, the fourth terminal of the ADC device 16 is electrically coupled to the digital signal outputted terminal 18.

In the preferred embodiment of the present invention, the voltage of the battery will decrease with the utility ratio. In order to solve the voltage is insufficient to cause the shut down during the operating procedure, the diode with a constant reference voltage is provided to replace the first resistor. According to Kirchhiff's voltage law, the current flows through the resistor 12, the diode 10, and the ADC device 16 should be equalized, when the battery provides a voltage to the measuring circuit. Thus, the outputted value at the digital signal outputted terminal 18 can be calculated from an equation such as Dₒᵤₜ=0.7/V_{DD}*Dₘₐₓ, wherein the Dₒᵤₜ is an outputted digital value of the digital signal outputted terminal 18, the value 0.7 is a numerical value of the diode 10, the V_{DD} is an inputted voltage of the battery, and the Dₘₐₓ is a variable of the ADC device 16, for example, the 8 bit represents the value is 255.

Therefore, the voltage of battery is decreased by increased of the outputted digital value of the digital signal outputted terminal. Furthermore, the voltage of the battery is sufficient for the measuring operation that can determine which according to that the measuring circuit has the device that can provide the constant voltage, and the actual voltage value can be determined by comparing the outputted digital value with the setting voltage within the measuring circuit.

Although specific embodiments have been illustrated and described, it will be obvious to those skilled in the art that various modifications may be made without departing from what is intended to be limited solely by the appended claims.

1. A measuring circuit structure to determine the voltage of the battery, said circuit structure comprising:
a device with a constant reference voltage, a first terminal of said device is electrically coupled to a second terminal of a resistor, and a second terminal of said device is grounded;
a voltage inputted terminal of said battery, said voltage inputted terminal is electrically coupled to a first terminal of said resistor; and
an analog to digital converting device, a first terminal of said analog to digital converting device is electrically coupled to said voltage inputted terminal of said battery, a second terminal of said analog to digital converting device is electrically coupled to said first terminal of said device with said constant reference voltage, a third terminal of said analog to digital converting device is electrically coupled to said second terminal of said device with said constant reference voltage, and a fourth terminal of said analog to digital converting device is electrically coupled to a digital signal outputted terminal.

2. The measuring circuit structure according to claim 1, wherein said device with said constant reference voltage is a diode.

3. The measuring circuit structure according to claim 1 wherein said device with said constant reference voltage is a diode.

4. The measuring circuit structure according to claim 1, wherein said device with said constant reference voltage is electrically coupled to said resistor in a series connection.

5. The measuring circuit structure according to claim 1, wherein said second terminal of said device with said constant reference voltage is grounded.

6. A method for determining the voltage of a battery, said method comprising:
providing a battery voltage into a measuring circuit, wherein said measuring circuit comprises a constant reference voltage;
converting said battery voltage of said measuring circuit into a digital signal; and
outputting said digital signal.

7. The method according to claim 6, wherein said providing said battery voltage is a voltage-inputted terminal of a battery.

8. The method according to claim 6, wherein said device with said constant reference voltage is a diode.

9. The method according to claim 6, wherein said measuring circuit further comprising a resistor.

10. The method according to claim 6, wherein a first terminal of said device with said constant reference voltage is electrically coupled to a second terminal of said resistor in a series connection.

11. The method according to claim 6, wherein a second terminal of said device with said constant reference voltage is grounded.

12. The method according to claim 6, further comprising a first terminal of said resistor is electrically coupled to said voltage inputted terminal of said battery.

13. The method according to claim 6, wherein said measuring circuit further comprising an analog to digital converting device.

14. The method according to claim 13, wherein said analog to digital converting device comprises at least four terminals, wherein a first terminal of said analog to digital converting device is electrically coupled to said voltage inputted terminal, a second terminal of said analog to digital converting device is electrically coupled to a connecting point that between said first terminal of said device with said constant reference voltage and said second terminal of said resistor, a third terminal of said analog to digital converting device is electrically coupled to said second terminal of said device with said constant reference voltage, and a fourth terminal of said analog to digital converting device is electrically coupled to a digital signal outputted terminal.
